(19) United States
(12) Patent Application Publication
(10) Pub. No.: US 2026/0022994 A1
(43) Pub. Date: Jan. 22, 2026

(54) PIPETTING DEVICE

(71) Applicant: BRAND GMBH + CO KG, Wertheim (DE)

(72) Inventors: Josef Pfohl, Külsheim (DE); Michael Ertl, Marktheidenfeld (DE); Tom Grein, Wertheim (DE); Markus Kurz, Wertheim (DE); Jan Bundschuh, Külsheim (DE)

(21) Appl. No.: 19/270,069

(22) Filed: Jul. 15, 2025

(30) Foreign Application Priority Data
Jul. 16, 2024 (DE) 10 2024 002 311.9

(51) Int. Cl. G01N 1/14

(52) U.S. Cl. CPC G01N 1/14

(57) ABSTRACT

A pipetting device for aspirating and dispensing fluid volumes, having a displacer with a displacer mechanism and a displacer housing, a rotatable setting device which can be manually operated by a user for adjusting a pipetting volume of the pipetting device, a stop, the position of which is adjustable and determines a stroke of the displacer mechanism, the pipetting volume being defined by the stroke of the displacer mechanism, and a coupling device coupled to the setting device for coupling the setting device to the stop. The pipetting device has a protective mechanism for limiting torque transmission from the setting device to the coupling device, in such a way that the setting device and the coupling device move together, and above the threshold value the torque and/or force transmission is reduced or interrupted.

### BACKGROUND OF THE INVENTION

### Field of the Invention

The present invention relates to a pipetting device for picking up and dispensing fluid volumes or for handling liquid having a displacer device, in particular a piston/cylinder arrangement, with a displacer piston, in particular a piston, and a displacer housing, in particular a cylinder, a setting means which can be manually operated by a user for setting a pipetting volume of the pipetting device, the setting means being rotatable for setting the pipetting volume, in particular about a longitudinal axis of the pipetting device, a stop, the position of which is adjustable and determines a stroke of the displacer piston, the pipetting volume being defined by the stroke of the displacer piston (4), and a coupling device coupled to the setting means for coupling the setting means to the stop.

### Description of Related Art

In principle, pipetting devices are known from the prior art.

Pipetting devices known from the prior art usually have a setting means for setting a pipetting volume. The setting means is also referred to as a volume setting knob or volume setting wheel. To adjust or set the pipetting volume, the setting means is rotated by a user, in particular about a longitudinal axis of the pipetting device. The setting means is non-rotatably connected to a coupling device that drives other functions or functional groups or components of the pipetting device, for example, a volume display for displaying the set pipetting volume. The coupling device can be designed as a setting sleeve and drive the display via an external gear rim at the lower end of the setting sleeve and drive a lifting rod of the pipetting device via an internal gear rim at the upper end or be coupled or connectable to it.

The solution known from the prior art has the disadvantage that functions of the pipetting device can be executed incorrectly, or components of the pipetting device can be damaged or destroyed (sometimes irreversibly) if the user applies too much force or too much torque when turning the setting means.

### SUMMARY OF THE INVENTION

It is an object of the present invention to provide a pipetting device which is protected against damage, destruction and/or malfunctions due to improper use, in particular due to excessive application of force when setting a pipetting volume.

The above object is solved by a pipetting device according to the invention which is designed for receiving and dispensing fluid volumes and has a displacer device, in particular a piston/cylinder arrangement, with a displacer piston, in particular a piston, and a displacer housing, in particular a cylinder.

Furthermore, the pipetting device according to the invention has a setting means which can be manually operated by a user for setting a pipetting volume of the pipetting device. The setting means is rotatable for adjusting the pipetting volume, in particular about a longitudinal axis of the pipetting device. The setting means can also be referred to as a volume adjustment knob or volume adjustment wheel.

Furthermore, the pipetting device according to the invention has a stop and a coupling device coupled to the setting means for coupling the setting means to the stop. The position of the stop is adjustable, and the stop or its position determines a stroke of the displacer piston, whereby the pipetting volume is defined by the stroke of the displacer piston. The coupling device is coupled or can be coupled to the stop in such a way that a rotation of the setting means causes a change in the position of the stop by the coupling device, so that the stroke of the displacer piston and thus the pipetting volume is changed.

According to the invention, the pipetting device has a protective mechanism for limiting a torque and/or force transmission from the setting means to the coupling device, so that below a threshold value of a torque acting on the adjusting element or a force acting on the adjusting element, the adjusting element is coupled to the coupling device in such a way that the adjusting element and the coupling device move together and above the threshold value the torque and/or force transmission is reduced or interrupted. In particular, below the threshold value, the setting means is coupled to the coupling device in a rotationally fixed manner. In other words, the protective mechanism limits the transmission of torque and/or force from the setting means to the coupling device, so that this transmission of torque and/or force is reduced or interrupted above the threshold value.

This has the advantage that the power transmission or torque transmission is interrupted at a certain threshold value, i.e., a defined overload. This protects the coupling device or parts coupled to it from damage or destruction due to user errors. The operation of the pipetting device can thus be made safer.

In addition, without the protective mechanism, excessive force or torque input via the setting means can lead to functional errors, instability and thus impair the precision of pipetting processes carried out with the pipetting device. The protective mechanism, therefore, also ensures precision when using the pipetting device.

It is preferable that the protective mechanism is designed as a slip clutch or has a slip clutch. This makes it easy to interrupt the transmission of force or torque above a certain torque or force.

The threshold value is preferably at least 2 Ncm and/or at most 12 Nem, in particular between 5 Ncm and 9 Ncm. On the one hand, this enables reliable coupling during proper use of the pipetting device and, on the other hand, effective protection against excessively high force or torque inputs, which could lead to damage, destruction or impairment of precision.

The protective mechanism preferably has at least one protective element. Preferably, the protective element is arranged within the pipetting device, and/or the protective element effects a torque- or force-dependent coupling of the setting means with the coupling device. In this way, the protective mechanism can be realized in a simple and reliable manner.

The protective element is preferably arranged within the setting means and/or accommodated in the setting means and/or arranged between the setting means and the coupling device. Thus, the protective mechanism is not visible to the user and furthermore does not interfere with the operation of the pipetting device by the user.

It is preferred that the setting means has a preferably cylindrical coupling section for coupling the setting means to the coupling device, in particular wherein the protective element, in particular the O-ring or snap ring, surrounds the coupling section or vice versa. This has proven to be particularly effective and advantageous during manufacture.

The protective element is preferably annular, in particular an O-ring and/or snap ring. This allows the protective mechanism, in particular a slip clutch, to be realized in a simple and cost-effective manner.

Preferably, the setting means is or is pressed against the coupling device by means of the protective element, so that the setting means and the coupling device are connected to each other below the threshold value in a frictionally engaged and, in particular, non-rotatable manner. This causes a coupling and force or torque transmission between the setting means and the coupling device at forces or torques below the threshold value.

The setting means preferably has a receiving space that is designed as an annular gap and in which the protective element is accommodated. This saves space and protects the protective element from manipulation and contact with other parts or components, ensuring that the protective mechanism functions reliably.

The protective element is preferably detachably coupled, in particular latched, to the setting means or the coupling device. Preferably, the setting means or the coupling device has a toothing means and/or the protective element engages in the setting means or the coupling device, in particular the toothing means. In this way, the desired force- or torque-dependent coupling, in particular the reduction or interruption of the force or torque transmission above the threshold value, is reliably achieved in a structurally simple manner.

Preferably, the protective element is held or fastened to the coupling device or the setting means, in particular with a positive fit. This is conducive to simple assembly and safe or reliable function.

It is preferable that the protective element is bendable or deformable in such a way that when the threshold value is reached or exceeded, the coupling of the setting means with the coupling device mediated by the protective element is canceled by a deformation of the protective element; it is particularly preferable that the protective element is reversibly deformable. This mechanism has proven to be particularly advantageous for realizing the force- or torque-dependent coupling, in particular the reduction or interruption of the force or torque transmission above the threshold value.

Preferably, the protective element is made of metal and/or the protective element is elastic and/or resilient. The protective element is particularly preferably a leaf spring or a stamped-bent part. This is advantageous for a long service life or reliable function over a long period of time.

The setting means is preferably arranged at an axial end of the coupling device, in particular attached to the axial end and/or inserted into the axial end. This enables simple assembly or integration of the protective mechanism. If the setting means is plugged in, the coupling section with the protective element is preferably located on the coupling device.

According to a preferred aspect, the setting means and the coupling device have latching elements assigned to each other, whereby the setting means is positively secured against removal from the coupling device in the direction of a longitudinal axis of the coupling device or pipetting device by means of the latching elements. This means that the protective mechanism, in particular its protective element, cannot be removed from the pipetting device.

The aforementioned coupling device is preferably a sleeve-shaped component.

The coupling device is preferably coupled or can be coupled to a volume display for displaying the set pipetting volume, in particular via a toothing means, for example, a gear rim, a gear wheel and/or a gear rack. However, other solutions are also possible here, for example, coupling the coupling device to the display by means of a belt drive or a friction-locking coupling of the coupling device to the display.

Preferably, the pipetting device has a drive device for moving the displacer piston in the displacer housing, whereby a movement of the displacer piston is limited by an upper stop, a lower stop and at least one counter-stop of the drive device and/or the displacer piston, so that the stroke of the displacer piston is defined. In this case, the aforementioned stop, the position of which is adjustable and defines the stroke of the displacer piston, is formed by the upper stop or the lower stop.

The aforementioned aspects and features as well as the aspects and features of the present invention resulting from the further description can be realized independently of one another, but also in any combination.

Further advantages, features, characteristics and aspects of the present invention are apparent from the following description of a preferred embodiment with reference to the drawing.

### BRIEF DESCRIPTION OF THE DRAWINGS

FIG. 1 shows a perspective view of a pipetting device according to the invention;

FIG. 2 shows a sectional view of the pipetting device according to the invention;

FIG. 3 shows a side view of a section of the pipetting device according to the invention with a setting means and a coupling device;

FIG. 4 shows a sectional view of the section shown in FIG. 3 with a protective mechanism according to a first embodiment;

FIG. 5 shows an exploded view of the section shown in FIG. 4 with a protective mechanism according to the first embodiment;

FIG. 6 shows an exploded view of the section shown in FIG. 3 with a protective mechanism according to a second embodiment;

FIG. 7 shows a sectional view of the section shown in FIG. 6 with a protective mechanism according to the second embodiment;

FIG. 8 shows an exploded view of the section shown in FIG. 3 with a protective mechanism according to a third embodiment;

FIG. 9 shows a sectional view of the section shown in FIG. 8 with a protective mechanism according to the third embodiment; and

FIG. 10 shows a side view of selected components of the pipetting device according to the invention.

### DETAILED DESCRIPTION OF THE INVENTION

In the figures, the same reference signs are used for identical or similar parts, whereby corresponding properties and advantages can be achieved, even if a repeated description is omitted for reasons of simplification.

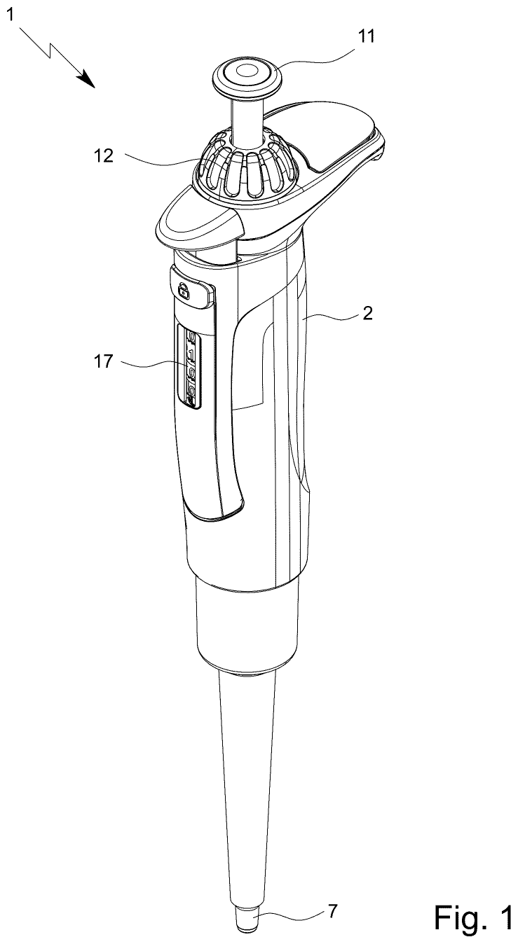

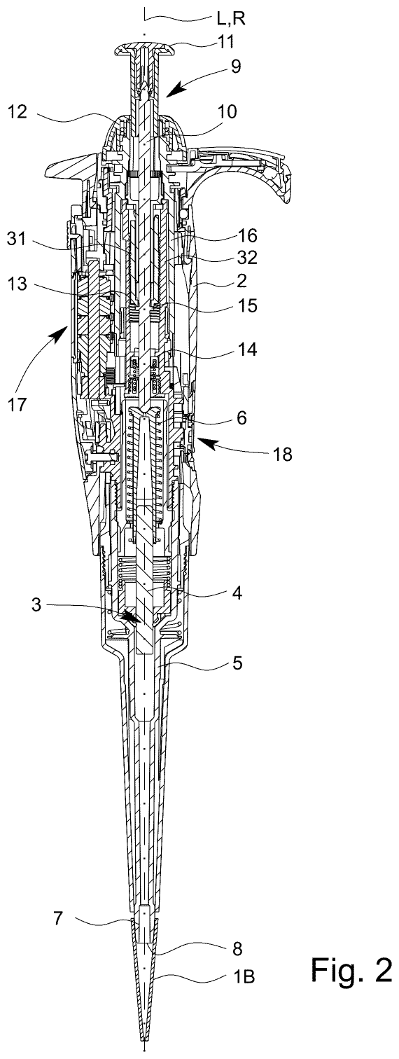

FIGS. 1 and 2 show a pipetting device 1 for aspirating and dispensing fluid volumes or for handling liquids in a perspective view and in a sectional view. The pipetting device 1 has a housing 2. The pipetting device 1 can be held and guided by hand by a user on the housing 2.

The pipetting device 1 features a displacer device 3, as illustrated in particular in FIG. 2. Through the use of the displacer device 3, a fluid, specifically a liquid, can be drawn into a pipette tip 1B and then dispensed from it again.

The displacer device 3 has a displacer piston 4 and a displacer housing 5. In the illustrated and preferred embodiment example, the displacer device 3 is designed as a piston/cylinder arrangement, so that the displacer piston 4 is designed as a piston and the displacer housing 5 is designed as a cylinder.

The pipetting device 1 and/or the displacer device 3 preferably has an elongated shape or has a longitudinal axis L. The longitudinal axis L preferably runs centrally through the displacer device 3, in particular the displacer piston 4 and the displacer housing 5.

When terms such as “axial”, “axial direction” and the like are used in the following, this refers to the longitudinal axis L. Accordingly, terms such as “radial”, “radial direction” and the like also refer to the longitudinal axis L and indicate a direction perpendicular to the longitudinal axis L. When terms such as “up”, “down” and the like are used in the following, this refers to the extension of the longitudinal axis L and in particular to the position of the pipetting device 1 shown in FIG. 1, which corresponds in particular to a position of use when the pipetting device 1 is used or held by a user.

The displacer housing 5 forms a cavity that is open towards a pipette tip 1B and is otherwise gas-tight. The displacer piston 4 is preferably movable axially and/or along the longitudinal axis L and in relation to the cavity. The volume of the cavity can be changed by means of the displacer piston 4, so that fluid can be drawn into the cavity when the cavity is enlarged due to the resulting negative pressure and can be released again or displaced from the cavity when the volume is reduced. The displacer piston 4 is preferably sealed against the displacer housing 5, in particular by means of a seal.

The displacer device 3 preferably has a return means 6, in particular a return spring. By means of the return means 6, the displacer piston 4 can be moved into an initial position, in particular into the position with the maximum volume of the cavity, which corresponds to the direction in which the fluid is drawn in or the direction opposite to the direction in which the fluid is discharged.

The displacer housing 5 preferably has or forms a shaft 7 of the pipetting device 1. The shaft 7 is used for detachably attaching the pipette tip 1B and has an opening 8, in particular at the end, which connects the displacer housing 5 to the pipette tip 1B, as already explained.

A pipette tip 1B is an essentially conical tube with two opposing openings, each with a different cross-section. With the larger opening, the pipette tip 1B can be attached to the shaft 7 and forms a gas-tight connection. Liquid can then be drawn into the pipette tip 1B through the variable cavity and then dispensed again.

The pipetting device 1 has a drive device 9 for moving the displacer 4 in the displacer housing 5. The drive device 9 preferably has a drive rod 10, which extends in particular axially and/or along the longitudinal axis L. The drive rod 10 is preferably movable in an axial direction and/or at least substantially parallel to the displacer piston 4.

The drive device 9 preferably has an operating element 11. The operating element 11 is preferably movable axially, in particular along the longitudinal axis L, and in particular can be pressed down in the direction of the housing 2. In particular, the drive device 9 can be actuated via the operating element 11, in particular moved along the longitudinal axis L.

Actuating the operating element 11, in particular pressing it down or moving it axially along the longitudinal axis L, causes the drive rod 10 to be pressed against the displacer piston 4, so that the displacer piston 4 moves into the displacer housing 5 and reduces the volume of the cavity. Accordingly, fluid can be dispensed from the pipetting device 1, in particular via the shaft 7 and the pipette tip 1B, by actuating the drive device 9 or the operating element 11.

When not actuated, the displacer piston 4 and the drive device 6 or the drive rod 10 and/or the operating element 11 automatically assume the initial position, in particular by means of the reset by the reset means 6.

Alternatively, or in addition to the operating element 11, automated or motorized actuation of the displacer device 3 is also possible.

The pipetting device 1 has an setting means 12 for adjusting a pipetting volume of the pipetting device 1.

The term “pipetting volume” refers to the (fluid) volume that can be picked up and/or dispensed by the pipetting device 1 during a pipetting process.

The setting means 12 can be operated manually by a user, in particular with one hand and/or with the thumb. Furthermore, the setting means 12 is rotatable, in particular about an axis of rotation R. The axis of rotation R is preferably identical to the longitudinal axis L of the pipetting device 1. However, other solutions are also possible here.

In particular, the pipetting volume can be adjusted or changed by rotating the setting means 12. The setting means 12 is therefore preferably designed as a volume adjustment wheel or volume adjustment knob.

Preferably, the operating element 11 and the setting means 12 are separate components and/or can be moved independently of each other. The operating element 11 is preferably not coupled to the setting means 12. In particular, the setting means 12 is not moved when the control element 11 is moved, and/or the control element 11 is not moved when the setting means 12 is moved.

The operating element 11 is preferably movable exclusively linearly and/or along the longitudinal axis L, in particular relative to the setting means 12. Preferably, the operating element 11 can be pressed down in the direction of the setting means 12. The operating element 11 is preferably not rotatable about the longitudinal axis Lor axis of rotation R. In other words, a linear movement along the longitudinal axis L is preferably the only possible movement of the operating element 11.

The setting means 12 is preferably exclusively rotatable, in particular about the axis of rotation R or longitudinal axis L and/or relative to the operating element 11. The setting means 12 is preferably fixed or fixed in a fixed axial position along the longitudinal axis L and/or cannot be moved linearly or along the longitudinal axis L. In other words, rotation about the rotation axis R is preferably the only possible movement of the setting means 12.

The pipetting device 1 has at least one stop 13, 14, the position of the stop 13, 14 being adjustable, in particular in the axial direction. The position of the stop 13, 14 determines or defines a stroke of the displacer piston 4. The stroke of the displacer piston 4 defines or determines the pipetting volume of the pipetting device 1.

Preferably, a movement of the displacer piston 4 is limited by an upper stop 13, a lower stop 14 and at least one counter-stop 15 of the drive device 6 and/or the displacer piston 4, so that a stroke of the displacer piston 4 is defined. Preferably, the stroke of the drive device 6 or the drive rod 10 or the displacer piston 4 can be changed by changing the position of the upper stop 13 and/or the lower stop 14.

Preferably, the upper stop 13 or the lower stop 14 forms the aforementioned stop 13, 14, the position of which is adjustable and defines the stroke of the displacer piston 4.

The counter stop 15 can be designed in particular as a stop section of the drive rod 10. In particular, the counter stop 15 is formed integrally with the drive rod 10 and/or extends from the drive rod 10 in a radial direction and/or is flange-like.

When the pipetting device 1, the displacer device 3 and/or the drive device 9 or the operating element 11 is actuated, in particular when the drive rod 10 is moved in the axial direction, the counter stop 15 preferably strikes against the lower stop 14, which limits the axial movement or stroke movement.

It is possible that the lower stop 14 can be moved past the counter stop 15 when a correspondingly high force is applied, which compresses the spring arranged below the lower stop 14. This movement of the lower stop 14 past the counter-stop 15 is also referred to as “overstroke” and allows liquid residue to be expelled from the pipetting device 1. However, this does not change the pipetting volume, which is defined as described by the normal stroke, which is limited by the contact between the lower stop 14 and the counter-stop 15.

When the displacer device 3 or the drive device 9 is reset, in particular by means of the reset means 6, there is preferably a stop between the counter stop 15 and the upper stop 13 in the suction direction, which limits the axial movement or stroke movement.

When the counter stop 15 strikes the upper stop 13, the unactuated state is preferably reached and/or the volume in the cavity is at a maximum. In particular, the maximum fluid volume or pipetting volume that can be accommodated is determined by the position of the upper stop 13.

Preferably, the axial position of the upper stop 13 can be adjusted so that the maximum fluid volume that can be accommodated or the pipetting volume or the volume of the cavity can be adjusted. For this purpose, the pipetting device 1 or the drive device 9 has the setting means 12. In principle, however, it is also possible that the position of the lower stop 14 can be adjusted alternatively or additionally.

The pipetting device 1 has a coupling device 16 which is coupled and/or connected to the setting means 12. The coupling device 16 is preferably a sleeve-shaped component, in particular an adjusting sleeve. The coupling device 16 is preferably cylindrical, at least in sections. The coupling device 16 preferably has a central and/or longitudinal axis, which is preferably identical to the longitudinal axis L of the pipetting device 1.

The coupling device 16 is coupled or can be coupled to the stop 13, 14 in such a way that a rotation of the setting means 12 causes a change in the position of the stop 13, 14 by means of the coupling device 16, so that the stroke of the displacer piston 4 and thus the pipetting volume is changed.

Preferably, the axial position of the upper stop 13 can be adjusted by means of the coupling device 16, in particular by rotating the coupling device 16, in particular about the longitudinal axis L.

Preferably, the upper stop 13 is arranged or formed on a sleeve 31. The upper stop 13 is preferably arranged or formed at an axial end, in particular the lower end, of the sleeve 31. The sleeve 31 is preferably coupled or couplable to the coupling device 16, so that a rotation of the coupling device 16 causes an axial displacement or change in the position of the upper stop 13. The sleeve 31 preferably has a coupling means, in particular an external thread, for coupling with the coupling device 16 or a component connected to the coupling device 16, in particular in a rotationally fixed manner. In the example shown, the pipetting device 1 has a coupling part 32, in particular a sleeve, which is connected to the coupling device 16 in a rotationally fixed manner and/or is arranged between the sleeve 31 and the coupling device 16. The coupling part 32 has a coupling means, in particular an internal thread, which is coupled to or engages with the coupling means or external thread of the sleeve 31, in particular so that a rotation of the coupling device 16 causes a change in the axial position of the upper stop 13. In principle, however, it is possible that instead of the coupling part 32, the coupling device 16 has the coupling means or internal thread or is coupled directly to the sleeve 31.

The pipetting device 1 preferably has a volume display 17, in particular arranged in the housing 2, which is designed to display the set pipetting volume. The volume display 17 can comprise a plurality of volume display wheels (number wheels) for displaying a volume value through an opening or window in the housing 2. The volume display 17 is coupled or can be coupled to the coupling device 16. In particular, the volume display 17 is driven by the coupling device 16 or (indirectly) by the setting means 12. Preferably, the volume display 17 and the coupling device 16 have coupling means corresponding to one another, via which the volume display 17 can be coupled to the coupling device 16, in particular toothing means such as gear rims, gear wheels or the like.

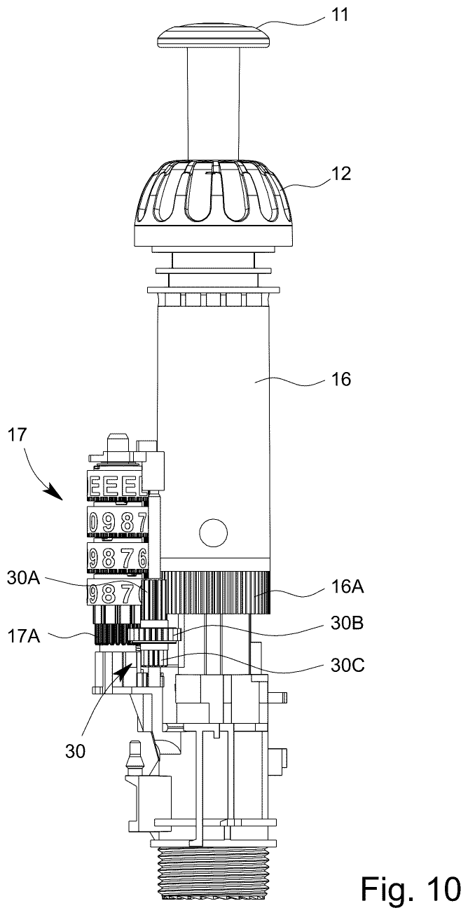

FIG. 10 shows a possible embodiment of the coupling means for coupling the coupling device 16 to the volume display 17. In the example illustrated in FIG. 10, the coupling device 16 and the volume display 17 are coupled or can be coupled to one another by means of a coupling unit 30. The coupling unit 30 preferably has a (first) toothing means or coupling means 30A, in particular a gear wheel, for coupling with a corresponding toothing means or coupling means 16A, in particular a gear wheel, of the coupling device 16. The coupling means 16A or gearwheel of the coupling device 16 is preferably arranged or formed on the outside of the coupling device 16. Furthermore, the coupling unit 30 preferably has a (second) toothing means or coupling means 30B, in particular a toothed wheel, for coupling with a corresponding toothing means or coupling means 17A, in particular a toothed wheel, of the volume display 17. The coupling means 30A, 30B of the coupling unit 30 are preferably arranged coaxially and/or one above the other and are preferably connected to each other in a rotationally fixed manner or via a gear.

In the position of the coupling unit shown in FIG. 10, which can also be referred to as the first position of the coupling unit 30, the (first) coupling means 30A of the coupling unit 30 is in engagement with the coupling means 16A of the coupling device 16 and the (second) coupling means 30B of the coupling unit 30 is in engagement with the coupling means 17A of the volume display 17, so that the volume display 17 is coupled to the coupling device 16 by means of the coupling unit 30 in such a way that a rotation of the coupling device 16 about the longitudinal axis L causes an adjustment of the volume display 17.

The coupling unit 30 is preferably axially movable, in particular parallel to the longitudinal axis L, in particular between the first position described above and a second position.

In the second position, the coupling unit 30 is preferably not coupled to the volume display 17. Preferably, in the second position, the (second) coupling means 30B is therefore not in engagement with the volume display 17 or its coupling means 17A.

In the second position of the coupling unit 30, it is preferably displaced downwards relative to the first position shown in FIG. 10. Preferably, the coupling unit 30 is (still) coupled to the coupling device 16 in the second position. Preferably, the coupling unit 30 has a (third) toothing means or coupling means 30C, which in the second position is coupled to the adjustment display 18 explained below, in particular so that a rotation of the coupling device 16 in the second position of the coupling unit 30 causes an adjustment of the adjustment display 18.

Furthermore, the pipetting device 1 can have an adjustment display 18 for displaying an adjustment value of the stroke of the displacer piston 3. The adjustment display 18 can be changed in an adjustment state. Preferably, the adjustment display 18 and the coupling device 16 have coupling means corresponding to one another, via which the adjustment display 18 can be coupled to the coupling device 16, in particular toothing means such as gear rims, gear wheels or the like.

According to the invention, the pipetting device 1 has a protective mechanism 19 for limiting torque transmission and/or force transmission from the setting means 12 to the coupling device 16.

The protective mechanism 19 is designed such that below a threshold value of a torque acting on the setting means 12 and/or a force acting on the setting means 12, the setting means 12 is coupled to the coupling device 16 such that the setting means 12 and the coupling device 16 move together and above the threshold value the torque transmission and/or force transmission is reduced or interrupted. Preferably, the setting means 12 is coupled to the coupling device 16 in a rotationally fixed manner below the threshold value.

A joint movement of the setting means 12 and the coupling device 16 within the meaning of the present invention is, in particular, a movement in the same direction and at the same speed. In other words, below the threshold value, the setting means 12 and the coupling device 16 are thus preferably firmly connected to one another, in particular rotationally fixed, and/or coupled to one another in such a way that they perform the same movement.

In this way, below the threshold value, the coupling device 16 can be moved, in particular rotated, and/or the pipetting volume of the pipetting device 1 can be adjusted or changed by means of the setting means 12, while above the threshold value a movement, in particular rotation, of the setting means 12 preferably does not result in a movement of the coupling device 16 and/or no or at least only reduced forces or torques are transmitted to other components of the pipetting device coupled to the coupling device 16. In this way, damage or malfunctions due to excessive force being applied via the setting means 12 can be prevented.

The protective mechanism 19 is designed in particular to prevent damage to the display 17 due to excessive force being applied when the setting means 12 is actuated.

The coupling device 16 is preferably always rotatable when the protective mechanism 19 does not interrupt the transmission of force or torque from the setting means 12 to the coupling device 16. The pipetting device 16 preferably has no components that can block or obstruct rotation of the coupling device 16.

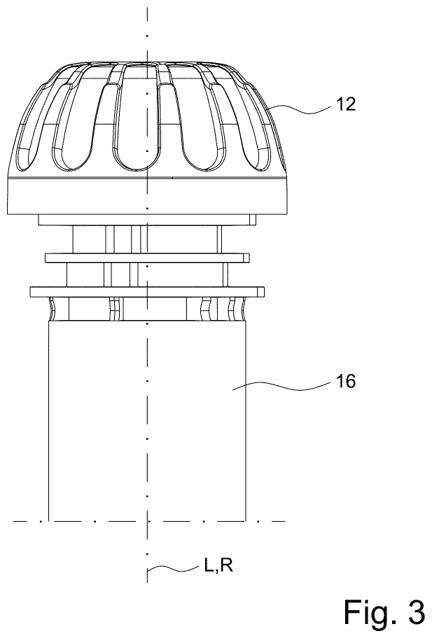

Various embodiments of the protective mechanism 19 are explained in more detail below, in particular with reference to FIGS. 3 to 9.

Preferably, the protective mechanism 19 is designed as a slipping clutch or the protective mechanism 19 has a slipping clutch. In other words, the setting means 12 and the coupling device 16 are preferably coupled or connected to each other by a slip clutch, in particular so that the setting means 12 slips or a rotation of the setting means 12 does not result in a rotation of the coupling device 16 when a torque or a force exceeds the threshold value.

The threshold value is preferably at least 2 Ncm and/or at most 12 Ncm. In particular, the threshold value is in a range between 5 Ncm and 9 Ncm. The threshold value preferably depends on the exact design of the protective mechanism 19 or the components involved in the protective mechanism 19 and can be determined accordingly by design, for example by the dimensions and/or the materials of the components involved.

The protective mechanism 19 preferably has at least one protective element 20. Preferably, the protective element 20 is formed by a separate component. However, the protective element 20 may also be formed by a section or region of a component of the pipetting device 1, in particular the setting means 12 or the coupling device 16.

A protective element 20 in the sense of the present invention is preferably a section, region, element or component of the pipetting device 1 which effects a torque- or force-dependent coupling of the setting means 12 with the coupling device 16.

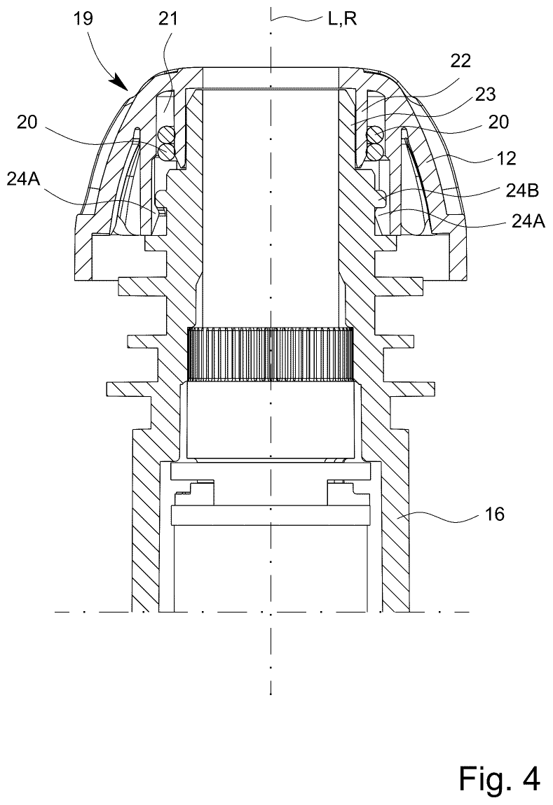

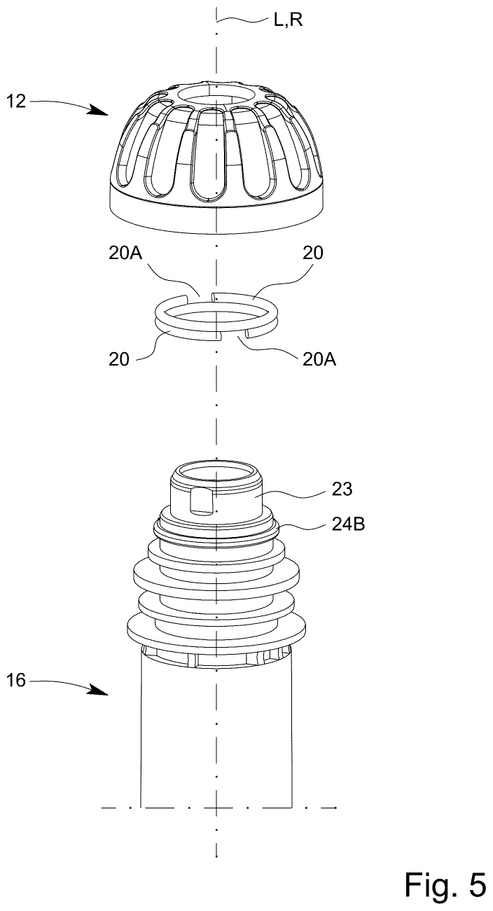

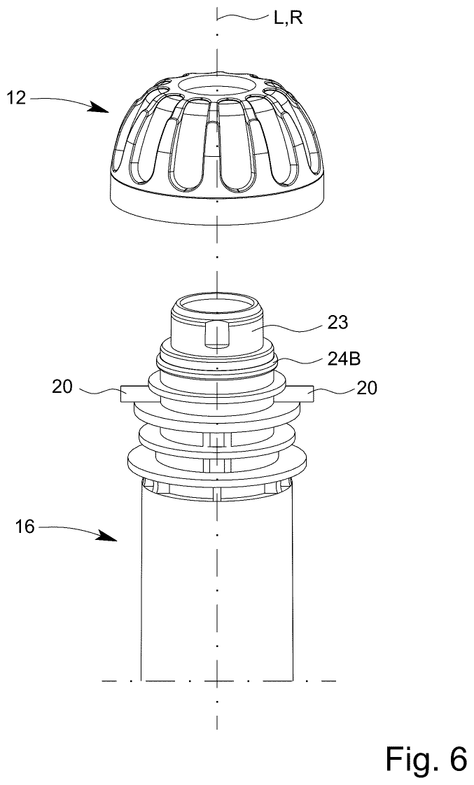

In the following, in particular a first embodiment of the protective mechanism 19 or protective element 20 is described in more detail, which is shown in FIGS. 4 and 5. A more detailed description of the second and third embodiments, which are shown in FIGS. 6 to 9, follows.

The protective element 20 according to the first embodiment is preferably annular and/or curved. In particular, the protective element 20 is an O-ring and/or snap ring.

A snap ring is in particular a retaining ring which consists of wire with a constant cross-section which is bent to form a ring. The circlip can be standardized or comply with DIN 9925:2019-12, but non-standardized circlips can also be used.

In particular, an O-ring is a ring-shaped sealing element that is preferably made of an elastomer. The O-ring can be standardized or comply with DIN ISO 3601, but non-standardized snap rings can also be used.

In the embodiment shown in the figures, the protective mechanism 19 has two protective elements 20 arranged one behind the other along the longitudinal axis L, both of which are designed as snap rings.

It is also possible that the protective mechanism 19 has several ring-shaped and/or curved protective elements 20, which are arranged in the same plane perpendicular to the longitudinal axis L. In particular, the protective mechanism 19 can have two or more protective elements 20, which are each formed as ring segments or circular segments and are arranged in the same plane perpendicular to the longitudinal axis L.

An annular protective element 20 within the meaning of the present invention is in particular a curved or bent component. The ring by which the annular protective element 20 is formed is not necessarily closed, but can also be an open ring or an annular segment or circular segment. In other words, the component forming the annular protective element 20 can describe a circumferential angle of less than 360°.

In the preferred embodiment shown in FIGS. 4 and 5, the protective element 20 is formed by a snap ring. A snap ring is a component that is bent in particular in a circular shape, for example a bent metal wire, with two ends that are spaced apart, as shown in particular in FIG. 5. Thus, although the protective element 20 or the snap ring is ring-shaped, it is not a closed ring but an open ring.

The protective element 20 can be made of plastic, metal or ceramic.

In particular, the protective element 20 is elastic or elastically deformable.

Preferably, the setting means 12 is pressed against the coupling device 16 by means of the protective element 20 or vice versa, so that the setting means 12 and the coupling device 16 are frictionally connected to one another below the threshold value. The protective element 20 therefore preferably exerts a force against the setting means 12 in the direction of the coupling device 16, in particular in a radial direction and/or inwards or in the direction of the longitudinal axis L. However, it is also possible that the protective element 20 exerts a force against the coupling device 16 in the direction of the setting means 12, in particular in the radial direction and/or outwards.

The protective element 20 is preferably arranged within the setting means 12 and/or accommodated in the setting means 12. This is shown in particular in FIG. 4. As a result, the protective element 20 is preferably not visible to the user and/or inaccessible to the user and/or protected against contact with other components, so that malfunctions of the protective mechanism 19 in particular can be avoided.

However, it is also possible that the particularly ring-shaped protective element 20 is arranged on or attached to the coupling device 16, in deviation from the representation in the figures. For example, the setting means 12 can be inserted or inserted into the coupling device 16, in particular so that an upper axial end 23 of the coupling device 16 surrounds the setting means 12 or a section thereof. The protective element 20 can thereby be arranged on the outside of the upper axial end 23 of the coupling device 16, so that it exerts a radially inwardly directed force on the coupling device 16 and the protective element 20 and the coupling device 16 and the protective element 20 are frictionally connected to one another below the threshold value by the exerted force.

In general, however, it is also possible for the protective element 20 to act in the axial direction, particularly if the protective element acts on the basis of a latching action. Below the threshold value, the setting means 12 can therefore be positively connected or coupled, in particular latched, and/or frictionally connected or coupled in the axial direction to the coupling device by means of an appropriately designed protective element 20. In these embodiments, the protective element 20 is not necessarily annular in shape and is preferably not arranged on the inside or outside, but on the underside or top.

Another possible design of the protective mechanism 19 is a magnetic coupling, which can act both axially and radially.

The setting means 12 preferably has a receiving space 21 for receiving the protective element 20. The receiving space 21 is preferably designed as an annular or cylindrical gap. In particular, the receiving space 21 is arranged coaxially to the longitudinal axis L. The protective element 20 is preferably arranged in the receiving space 21. The receiving space 21 is preferably formed by two at least substantially cylindrical, coaxially arranged and axially extending sections of the setting means 12 or is delimited in the radial direction.

Preferably, the setting means 12 has a coupling section 22, in particular of cylindrical design, which is designed for coupling the setting means 12 to the coupling device 16. Preferably, the protective element 20 surrounds the coupling section 22, which is shown in particular in FIG. 4. However, it is also possible that the coupling section 22 surrounds the protective element 20. The coupling section 22 is preferably arranged coaxially to the protective element 20 and/or the longitudinal axis L.

The coupling section 22 preferably forms an inner wall or boundary of the receiving space 21.

The setting means 12 is preferably arranged at an axial end 23 of the coupling device 16, in particular at the upper axial end 23 facing the operating element 11, as shown in the figures. Preferably, the setting means 12 surrounds the axial end 23. In particular, the setting means 12 is plugged onto and/or inserted into the coupling device 16 or the axial end 23. The axial end 23 preferably represents an at least substantially rotationally symmetrical, preferably cylindrical section of the coupling device 16. Preferably, the axial end 23 is arranged coaxially to the longitudinal axis L, the setting means 12 or coupling section 22, the receiving space 21 and/or the protective element 20.

Particularly preferably, therefore, the setting means 12 is attached to the coupling device 16, in particular its axial end 23, by means of the cylindrical coupling section 22, with the protective element 20 pressing the coupling section 22 against the axial end 23. As a result, the setting means 12 is coupled to the coupling device 16 due to a frictional connection between the coupling section 22 and the axial end 23, so that at torques below the aforementioned threshold value there is a non-rotatable connection between the setting means 12 and the coupling device 16. At torques above the threshold value, the slipping clutch formed by the protective element 20, the coupling section 22 and the axial end 23 slips, so that the pure connection or non-rotational coupling is/will be released and a rotation of the setting means 12 is not transmitted to the coupling devices 16.

In the case of the ring-shaped protective element 20, the coupling of the setting means 12 with the coupling device 16 is preferably based on the radial force effect of the protective element 20. The radial force effect can be caused on the one hand by inserting the protective element 20 into the receiving space 21 or attaching the protective element 20 to the coupling section 22. On the other hand, however, a radial force effect can also be produced by inserting the protective element 20, in particular the elastic protective element 20, into the receiving space 21 under compression.

In the event that the coupling section 22 surrounds the protective element 20, the receiving space 21 presses outwards against the coupling device 16 due to the compressed protective element 20.

As already explained above, an embodiment is also possible in which the coupling device 16 has the receiving space 21 and the setting means 12 is inserted into the coupling device 16.

Preferably, the inner wall of the receiving space 21 has slots (not shown in the figures) which provide additional elasticity to the inner wall so that it can be pressed more effectively against the coupling device 16 by the force of the protective element 20.

The setting means 12 and the coupling device 16 preferably have latching elements 24A, 24B assigned to one another. By means of the latching elements 24A, 24B, the setting means 12 is preferably secured against removal from the coupling device 16 in the axial direction or in the direction of the longitudinal axis L, in particular by a positive connection or latching connection formed between the latching elements 24A, 24B. This prevents (unintentional) removal of the setting means 12 from the coupling device 16.

The latching element 24B of the coupling device 16 is preferably arranged below the axial end 23.

In particular, the latching element 24B of the coupling device 16 is formed by a section which runs around a cylindrical section of the coupling device 16 and/or projects radially therefrom.

The latching element 24A of the setting means 12 is preferably arranged or formed on an axial extension of the section that forms an outer boundary of the receiving space 21. The latching element 24A is designed to engage behind the latching element 24B of the coupling device 16. For this purpose, the latching element 24A has a corresponding shape. The latching element 24A is preferably designed as a latching hook or hook-shaped.

Preferably, the setting means 12 has several latching elements 24A arranged offset in the circumferential direction. In the example shown, the setting means 12 has six identical latching elements 24A, each of which is offset by 60° in the circumferential direction.

The pipetting device 1 or the protective mechanism 19 can have two or more protective elements 20. The above explanations regarding the protective element 20 preferably apply to all protective elements 20 of the pipetting device 1 or the protective mechanism 19. If the protective mechanism 19 has two or more protective elements 20, these are preferably of identical construction.

In the particularly preferred embodiment shown in FIGS. 4 and 5, the protective mechanism 19 has exactly two protective elements 20. The protective elements 20 are each designed as a snap ring and are arranged in such a way that the free spaces 20A, i.e. the areas located between the two ends of a snap ring, of the snap rings are diametrically opposite each other with respect to the longitudinal axis L. This is shown in particular in FIG. 5.

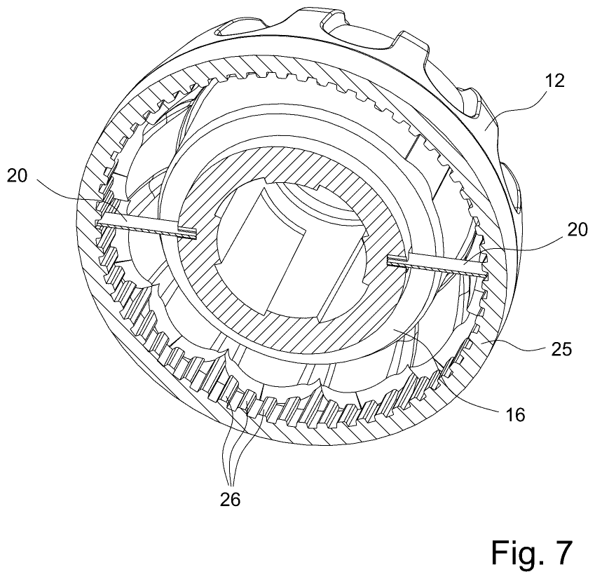

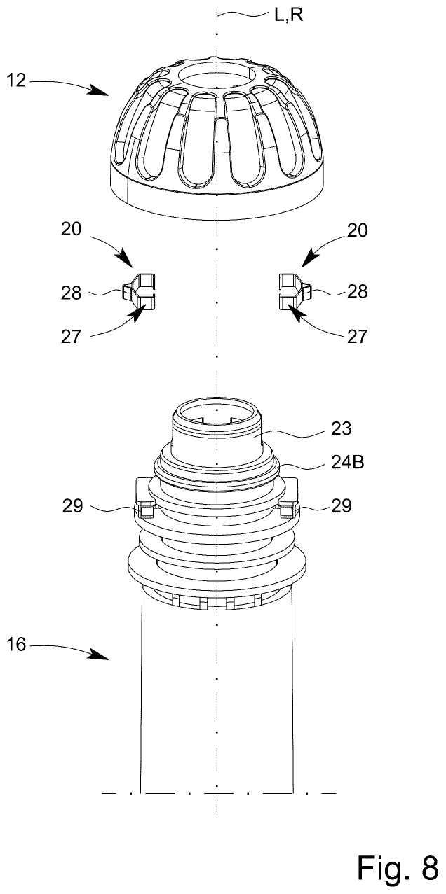

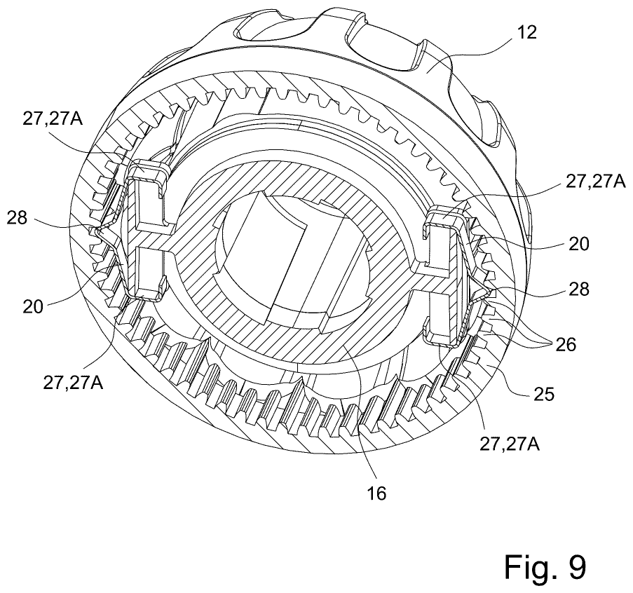

A second and third embodiment, which are shown in FIGS. 6 to 9, are described in more detail below. FIGS. 6 and 7 show different representations of the second embodiment, while FIGS. 8 and 9 show different representations of the third embodiment.

The previous explanations with reference to the first embodiment also apply to the second and third embodiments, unless incompatibilities or obvious contradictions arise or something else is explicitly mentioned.

In the second and third embodiments, the coupling of the setting means 12 with the coupling device 16 below the threshold value is preferably effected by a (detachable or surmountable) positive connection, in particular latching. In other words, in these embodiments, the setting means 12 is thus—at least indirectly—positively connected or latched to the coupling device 16.

Preferably, in the second and third embodiments, the protective mechanism 19 also has at least one protective element 20. In particular, the protective element 20 below the threshold value mediates the coupling, in particular positive connection or latching, of the setting means 12 to the coupling device 16.

Preferably, the protective element 20 is therefore detachably coupled, in particular latched, to the setting means 12 or the coupling device 16.

The protective element 20 is preferably formed as a separate component, but can in principle also be formed in one piece with the setting means 12 or the coupling device 16 or form a section of the setting means 12 or the coupling device 16.

The protective element 20 is preferably arranged between the setting means 12 or an inner side of the setting means 12 and the coupling device 16 or an outer side of the coupling device 16.

Preferably, the setting means 12 or the coupling device 16 has a toothing means 25, in particular a gear rim. The protective element 20 preferably engages in the setting means 12 or the coupling device 16, in particular in the toothing means 25. The engagement of the protective element 20 in the toothing means 25 preferably realizes the aforementioned coupling, in particular (positive) connection or latching, of the setting means 20 with the coupling device 16.

A toothing means 25 within the meaning of the present invention is, in particular, a component or section with a plurality of teeth 26. In the examples shown, the toothing means 25 is in each case designed as a gear rim. In principle, however, the toothing means 25 can also be designed differently, for example as a toothed rack or toothed wheel.

The protective element 20 is preferably held or fastened to the coupling device 16 or the setting means 12, in particular by means of a positive connection. Alternatively or additionally, however, another type of fastening can also be provided, for example bonding and/or a frictional connection.

Preferably, the protective element 20 is arranged on the outside of the coupling device 16.

Preferably, therefore, one of the components setting means 12 and coupling device 16 has the protective element 20, while the protective element 20 engages in the other of the two components, in particular wherein the other of the two components has the toothing means 25. In the example shown, the coupling device 16 has the protective element 20 and engages in the setting means 12 or a toothing means 25 of the setting means 12. In principle, however, a reverse arrangement is possible, in which the setting means 12 has the protective element 20 and engages in the coupling device 16 or a toothing means 25 of the coupling device 16.

If the setting means 12 has the toothing means 25, this is preferably arranged on an inner side of the setting means 12 and/or designed as an inner-sided gear rim. This is shown in FIGS. 7 and 9. If the coupling device 16 has the toothing means 25, this is preferably arranged on an outer side of the coupling device 16 and/or is formed as an outer-sided gear rim.

Preferably, the protective element 20 or at least a section thereof is elastic and/or resilient.

The protective element 20 is preferably deformable or bendable, in particular reversibly deformable or bendable, in particular so that the force or torque transmission from the setting means 12 to the coupling device 16 is/is reduced or interrupted above the threshold value.

Particularly preferably, the protective element 20 is (elastically) deformable in such a way that when the threshold value is reached or exceeded, the coupling of the setting means 12 to the coupling device 16 mediated by the protective element 20 is canceled due to the deformation of the protective element 20.

The threshold value is preferably adjustable by the specific design of the protective element 20 and/or the spider 25.

The protective element 20 and preferably the toothing means 25 are thus preferably designed and/or matched to each other in such a way that below the threshold value there is a (rotationally fixed) coupling of the setting means 12 with the coupling device 16, in particular by the engagement of the protective element 20 in the toothing means 25, and above the threshold value the coupling is canceled or reduced, in particular by the protective element 20 deforming/bending in such a way that one or more teeth 26 of the toothing means 25 move past or “slip through” the protective element 20. “slip through”.

In the second and third embodiments, the protective element 20 is preferably made of metal.

In the second embodiment, the protective element 20 is preferably designed as a leaf spring. In particular, the protective element 20 or the leaf spring is flat, elongate and/or at least substantially rectangular. The protective element 20 or the leaf spring preferably extends at least substantially radially and/or in a plane which is parallel to the longitudinal axis L and/or axis of rotation R and/or contains these. Preferably, the coupling device 16 has a recess, in particular a slot-like recess, in which the protective element 20 and/or the leaf spring is arranged, held and/or fastened.

In the third embodiment, the protective element 20 is preferably designed as a stamped-bent part.

Preferably, in the third embodiment, the protective element 20 or stamped-bent part has a fastening section 27 and an engagement section 28. Preferably, the fastening section 27 and the engagement section 28 have different geometric shapes.

The fastening section 27 of the protective element 20 is preferably designed for positive connection to a fastening section 29 of the coupling device 16 or the setting means 12. The fastening section 29 is preferably designed or shaped to correspond to and/or complement the fastening section 27 of the protective element 20. In the example shown, the fastening section 29 is arranged on the outside of the coupling device 16 and, in particular, is formed integrally with the coupling device 16.

Preferably, the fastening section 27 has two fastening elements 27A, which are in particular formed in the same way, symmetrical and/or opposite one another, in particular approximately U-shaped. The engagement section 28 is preferably arranged between these fastening elements 27A of the fastening section 27.

The engagement section 28 is preferably designed to engage with the toothing means 25. Preferably, the engagement section 28 protrudes in the direction of the toothing means 25 and/or the engagement section 28 can be arranged between two teeth 26 of the toothing means 25, so that the engagement section 28 engages positively in the toothing means 25 and effects the coupling below the threshold value.

The engagement section 28 preferably has two legs that are arranged symmetrically and/or at an angle to one another and/or is preferably pointed and/or V-shaped.

The engagement section 28 is preferably elastic and/or resilient, in particular so that the transmission of force or torque from the setting means 12 to the coupling device 16 is/is reduced or interrupted above the threshold value.

Preferably, the protective element 20 or stamped-bent part is made from a preferably stamped-out and/or flat piece of metal or sheet metal, which is bent or deformed in such a way that it has the fastening section 27 and the engagement section 28.

The protective element 20 or stamped-bent part is preferably designed to be clamp-like and/or symmetrical.

In the example illustrated, the protective element 20 is designed as a type of clamp which is held or can be fastened to the coupling device 16 or its fastening section 29 by means of the fastening section 27 in a form-fitting and/or friction-fitting or clamping manner and engages in the toothing means 25 of the setting means 12 by means of a radially outwardly projecting or protruding engagement section 28.

In the second and third embodiments, the protective mechanism 19 preferably has two protective elements 20, which in particular are of identical construction and/or are arranged symmetrically. The protective elements 20 are preferably arranged on opposite sides of the longitudinal axis L and/or rotation axis R. The preceding explanations with respect to the protective element 20 of the second and/or third embodiment preferably apply to all protective elements 20 in these embodiments.

Individual aspects of the invention described above can be realized independently of one another, but also in any combination, and can be advantageous.

### LIST OF REFERENCE SIGNS

1 Pipetting device
1B Pipette tip
2 Housing
3 Displacer device
4 Displacer piston
5 Displacer housing
6 Resetting means
7 Shaft
8 Opening
9 Drive device
10 Actuator stem
11 Operating element
12 Setting means
13 Upper stop
14 Lower stop
15 Counter stop
16 Coupling device
16A Coupling means of 16
17 Volume display
17A Coupling means of 17
18 Adjustment display
19 Protection mechanism
Protective element
20A Clearance from 20
21 Recording space
22 Coupling section
23 Axial end of 16
24A Latching element of 12
24B Latching element of 16
25 Toothing means
26 Teeth from 25
27 Fastening section of 20
27A Fastening element of 27
28 Engagement section of 20
29 Fastening section of 12/16
30 Coupling unit
30A (first) coupling means of 30
30B (second) coupling means of 30
30C (third) coupling means of 30
31 Sleeve
32 Coupling part
L Longitudinal axis
R Axis of rotation

What is claimed is:

1. Pipetting device (1) for receiving and dispensing volumes of fluid, comprising
a displacer device (3) having a piston/cylinder arrangement, with a displacer piston, and a displacer cylinder,
a setting means (12) which can be manually operated by a user for setting a pipetting volume of the pipetting device (1), the setting means (12) being rotatable about a longitudinal axis (L) of the pipetting device for setting the pipetting volume,
a stop (13, 14), the position of which is adjustable and determines a stroke of the displacer piston (4), the pipetting volume being defined by the stroke of the displacer piston (4), and
a coupling device (16) coupled to the setting means (12) for coupling the setting means (12) to the stop (13, 14),
wherein the coupling device (16) is coupled or can be coupled to the stop (13, 14) in such a way that a rotation of the setting means (12) causes a change in the position of the stop (13, 14) by means of the coupling device (16), so that the stroke of the displacer piston (4) and thus the pipetting volume is changed,
wherein the pipetting device (1) has a protective mechanism (19) for limiting a torque and/or force transmission from the setting means (12) to the coupling device (16), so that below a threshold value of a torque acting on the setting means (12) and/or a force acting on the setting means (12), the setting means (12) is coupled to the coupling device (16) in such a way that the setting means (12) and the coupling device (16) move together, and above the threshold value, the torque and/or force transmission is reduced or interrupted.

2. Pipetting device according to claim 1, wherein the protective mechanism (19) is a slipping clutch or has a slipping clutch.

3. Pipetting device according to claim 1, wherein the threshold value is at least 2 Ncm and/or at most 12 Ncm.

4. Pipetting device according to claim 1, wherein the protective mechanism (19) comprises at least one protective element (20), and wherein the protective element (20) is arranged within the pipetting device (1) and/or effects a torque- or force-dependent coupling of the setting means (12) with the coupling device (16).

5. Pipetting device according to claim 4, wherein the protective element (20) is arranged within the setting means (12) and/or is received in the setting means (12) and/or is arranged between the setting means (12) and the coupling device (16).

6. Pipetting device according to claim 4, wherein the setting means (12) comprises a cylindrical coupling portion (22) for coupling the setting means (12) to the coupling device (16).

7. Pipetting device according to claim 4, wherein the protective element (20) is an O-ring and/or snap ring.

8. Pipetting device according to claim 4, wherein the setting means (12) is pressed against the coupling device (16) by means of the protective element (20), so that the setting means (12) and the coupling device (16) are frictionally connected to each other below the threshold value.

9. Pipetting device according to claim 4, wherein the setting means (12) has a receiving space (21) which is an annular gap and in which the protective element (20) is received.

10. Pipetting device according to claim 4, wherein the protective element (20) is releasably coupled to the setting means (12) or the coupling device (16), preferably wherein the setting means (12) or the coupling device (16) has a toothing means (25) and/or the protective element (20) engages in the setting means (12) or the coupling device (16), in particular the toothing means (25).

11. Pipetting device according to claim 10, wherein the protective element (20) is held or fastened to the coupling device (16) or the setting means.

12. Pipetting device according to claim 10, wherein the protective element (20) is deformable in such a way that, when the threshold value is reached or exceeded, the coupling of the setting means (12) to the coupling device (16) mediated by the protective element (20) is canceled by a deformation of the protective element (20), and wherein the protective element (20) is reversibly deformable, elastic and/or resilient.

13. The pipetting device according to claim 10, wherein the protective element (20) is is a leaf spring or a stamped-bent part.

14. Pipetting device according to claim 1, wherein the setting means (12) is arranged at an axial end (23) of the coupling device (16).

15. Pipetting device according to claim 1, wherein the setting means (12) and the coupling device (16) have mutually associated latching elements (24A, 24B), and wherein the setting means (12) is secured in a form-fitting manner against removal from the coupling device (16) in the direction of the longitudinal axis (L) of the coupling device (16) or pipetting device (1) by means of the latching elements (24A, 24B).

16. Pipetting device according to claim 1, wherein the coupling device (16) is a sleeve-shaped component.

17. Pipetting device according to claim 1, wherein the coupling device (16) is coupled or can be coupled via a toothing means to a display (17) for indicating the set pipetting volume, and wherein the protective mechanism (19) serves to prevent damage to the display (17) due to excessive force being applied when the setting means (12) is actuated.

18. Pipetting device according to claim 1, wherein the pipetting device (1) comprises
a drive device (9) for moving the displacer piston (4) in the displacer cylinder (5), wherein a movement of the displacer piston (4) is limited by an upper stop (13), a lower stop (14) and at least one counter-stop (15) of the drive device (9) and/or the displacer piston (4), so that the stroke of the displacer piston (4) is defined,
wherein the stop (13, 14), the position of which is adjustable and defines the stroke of the displacer piston (4), is formed by the upper stop (13) or the lower stop (14).

19. Pipetting device according to claim 1, wherein the setting means (12) is only rotatable about the longitudinal axis (L), and/or wherein the setting means (12) is fixed in a fixed axial position along the longitudinal axis (L).

20. Pipetting device according to claim 1, wherein pipetting device (1) comprises a drive device (9) for moving the displacer piston (4) in the displacer cylinder (5), wherein the drive device (9) comprises an operating element (11), wherein the operating element (11) is axially movable, in along the longitudinal axis (L) and/or relative to the setting means (12).
